(19) United States
(12) Patent Application Publication
(10) Pub. No.: US 2012/0176662 A1
(43) Pub. Date: Jul. 12, 2012

(54) Display Device

(76) Inventors: Ta-Nien LUAN, Hsinchu City (TW); Yen-Fong Liao, Toufen Township (TW); Chen-Yuan Sung, Toufen Township (TW); Chin-Hung Hsieh, Puxin Township (TW)

(21) Appl. No.: 13/269,293

(22) Filed: Oct. 7, 2011

(30) Foreign Application Priority Data
Jan. 11, 2011 (TW) 100100998

(51) Int. Cl. G02F 1/167

(52) U.S. Cl. 359/296

(57) ABSTRACT

A display device includes an array substrate, an electronic paper display medium, a counter substrate, a supporting layer, and an adhesive. The electronic paper display medium is disposed on the array substrate. The counter substrate is disposed on the electronic paper display medium. The adhesive adheres the supporting layer to a surface of the array substrate facing away from the electronic paper display medium.

### RELATED APPLICATIONS

This application claims priority to Taiwan Application Serial Number 100100998, filed Jan. 11, 2011, which is herein incorporated by reference.

### BACKGROUND

1. Technical Field

The present disclosure relates to a display device and more particularly to an electronic paper display device.

2. Description of Related Art

Electronic paper display devices, developed initially in the 1970s, are characterized by including small balls with electric charges. A surface of the ball is white, and another surface of the ball is black. When an electric field is changed, the ball would rotate up and down so as to display different colors. Second-generation electronic paper display devices are developed in the 1990s, and these electronic paper display devices are characterized by including tiny capsules filled with coloring oil and white pellets with electric charges instead of the traditional small balls. The white pellets moving upward or downward are controlled by an external electric field. When the white pellets move upward (i.e. being close to readers), the white pellets would display white color. When the white pellets move downward (i.e. being away from readers), the white pellets would display colors of the oil.

In general, most array substrates of the electronic paper display devices are made of glass. During manufacturing the electronic paper display devices, a glass motherboard would be cut into many array substrates. However, the damage defects formed on cutting surfaces are difficult to be prevented in glass cutting processes, so that if the array substrates suffer from falling, collision, and crush due to following processes or end customers' wrong behavior, the array substrates would start to break due to these defects, thereby reducing the yield and durability of products utilizing the electronic paper displayers.

### SUMMARY

Thus, an aspect of the present disclosure is to provide a display device. A supporting layer is further adhered on a back surface of an array substrate to strengthen the strength of the array substrate for solving easy-breaking problems.

In an embodiment of the present disclosure, a display device including an array substrate, an electric paper display medium, a counter substrate, a supporting layer, and an adhesive is provided. The electric paper display medium is disposed on the array substrate. The counter substrate is disposed on the electric paper display medium. The adhesive adheres the supporting layer to a surface of the array substrate facing away from the electronic paper display medium.

In one or other embodiments of the present disclosure, the supporting layer mentioned above completely covers the surface of the array substrate facing away from the electronic paper display medium.

In one or other embodiments of the present disclosure, the display device mentioned above further includes a protecting layer covering a side surface of the array substrate.

In one or other embodiments of the present disclosure, the protecting layer mentioned above is made of an ultraviolet (UV) curable material, a heat curable material, or combinations thereof.

In one or other embodiments of the present disclosure, the area of a surface of the supporting layer mentioned above facing the array substrate is larger than the area of the surface of the array substrate facing away from the electronic paper display medium, thereby forming at least one step surface between the supporting layer and the array substrate.

In one or other embodiments of the present disclosure, the display device mentioned above further includes a protecting layer covering the step surface between the supporting layer and the array substrate.

In one or other embodiments of the present disclosure, the protecting layer mentioned above further covers a side surface of the supporting layer.

In one or other embodiments of the present disclosure, the area of a surface of the supporting layer mentioned above facing the array substrate is equal to the area of the surface of the array substrate facing away from the electronic paper display medium.

In one or other embodiments of the present disclosure, the display device mentioned above further includes a protecting layer covering a side surface of the array substrate and a side surface of the supporting layer.

In one or other embodiments of the present disclosure, the area of a surface of the supporting layer facing the array substrate is smaller than the area of the surface of the array substrate facing away from the electronic paper display medium, thereby forming at least one step surface between the array substrate and the supporting layer.

In one or other embodiments of the present disclosure, the display device mentioned above further includes a protecting layer covering the step surface between the array substrate and the supporting layer.

In one or other embodiments of the present disclosure, the protecting layer mentioned above further covers a side surface of the array substrate.

In one or other embodiments of the present disclosure, the adhesive mentioned above is made of ultraviolet curable adhesive, double sided adhesive tape, or combinations thereof.

In one or other embodiments of the present disclosure, the supporting layer mentioned above is made of glass, tempered glass, metal, plastic, a flexible substrate, or combinations thereof.

The present display device utilizes the supporting layer to protect the back surface of the array substrate for strengthening the strength of the back surface of the array substrate. The present display device utilizes the protecting layer to protect the side surface of the array substrate for strengthening the strength of the side surface of the array substrate. The present display device utilizes the protecting layer to protect the step surface between the array substrate and the supporting layer so as to prevent the array substrate or the supporting layer from breaking.

### BRIEF DESCRIPTION OF THE DRAWINGS

FIG. 1 is a perspective view of a display device of an embodiment of the present disclosure;

FIG. 2 is a cross-sectional view taken along line 2-2 shown in FIG. 1;

FIG. 3 is a cross-sectional view of a display device of another embodiment of the present disclosure, and the cross section position is the same as the FIG. 2;

FIG. 4 is a cross-sectional view of a display device of another embodiment of the present disclosure, and the cross section position is the same as the FIG. 2;

FIG. 5 is a cross-sectional view of a display device of another embodiment of the present disclosure, and the cross section position is the same as the FIG. 2;

FIG. 6 is a cross-sectional view of a display device of another embodiment of the present disclosure, and the cross section position is the same as the FIG. 2; and

FIG. 7 is a cross-sectional view of a display device of another embodiment of the present disclosure, and the cross section position is the same as the FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

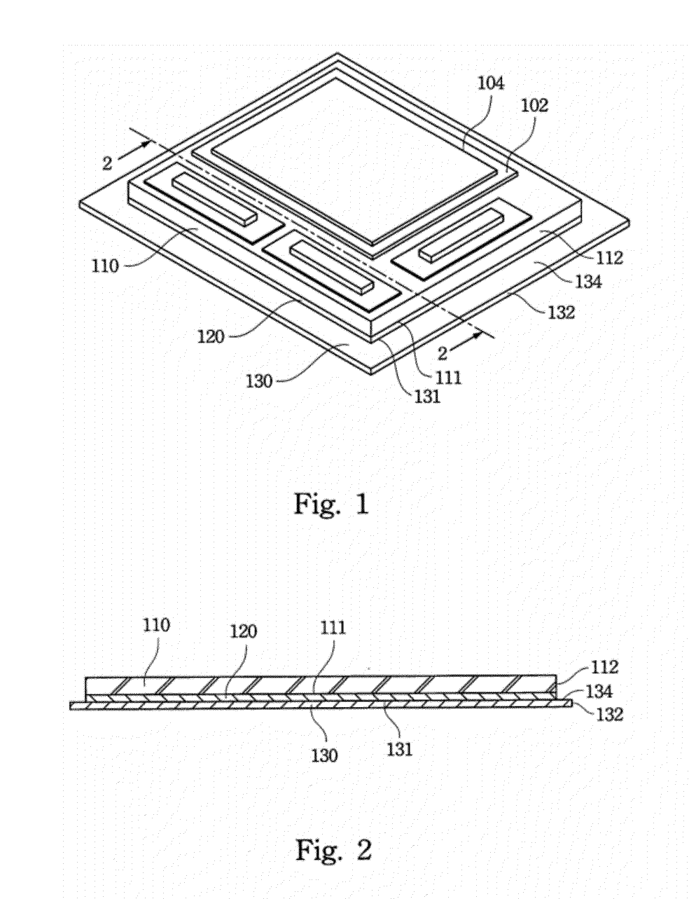

FIG. 1 is a perspective view of a display device of an embodiment of the present disclosure. FIG. 2 is a cross-sectional view taken along line 2-2 shown in FIG. 1. As shown in FIG. 1 and FIG. 2, a display device includes an array substrate 110, an electric paper display medium 102, a counter substrate 104, a supporting layer 130, and an adhesive 120. The electric paper display medium 102 is disposed on the array substrate 110. The counter substrate 104 is disposed on the electric paper display medium 102. The adhesive 120 adheres the supporting layer 130 to a surface 111 of the array substrate 110 facing away from the electronic paper display medium 102.

Comparing with a typical electric paper display, this display device utilizes the supporting layer 130 to protect the surface 111 of the array substrate 110 for redeeming defects possibly formed on the surface 111 of the array substrate 110, thereby preventing the array substrate 110 from breaking along the defects formed on the surface 111 when an external force is applied.

Because the defects caused by cutting processes are too small to be observed, the supporting layer 130 of the embodiment would completely cover the surface 111 of the array substrate 110 for substantially strengthening the strength of the surface 111 of the array substrate 110. Certainly, if the supporting layer 130 only covering a portion of the surface 111 of the array substrate 110 would provide sufficient strength in accordance with practical conditions, the supporting layer 130 can only cover a portion of the surface 111 of the array substrate 110. For example, in one or other embodiments of the present disclosure, the supporting layer 130 may have grid-shaped appearance to be adhered to the surface 111 of the array substrate 110.

In one or other embodiments of the present disclosure, the supporting layer 130 mentioned above may be made of glass, tempered glass, metal, plastic (e.g. Polycarbonate; PC, or Polyethylene terephthalate; PET), a flexible substrate, or combinations thereof. The materials of the supporting layer 130 mentioned above are only examples. Any materials having capability of protecting the array substrate 110 may be applied as the materials of the supporting layer 130. Person having ordinary skill in the art can selectively choose the materials of the supporting layer 130 in accordance with practical requirements.

In addition, in one or other embodiments of the present disclosure, the adhesive 120 mentioned above may be made of ultraviolet curable adhesive, double sided adhesive tape, or combinations thereof. Similarly, the materials of the adhesive 120 mentioned above are only examples. Any materials having capability of gluing the array substrate 110 and the supporting layer 130 may be used as the adhesive 120. Person having ordinary skill in the art can selectively choose the materials of the adhesive 120 in accordance with practical requirements.

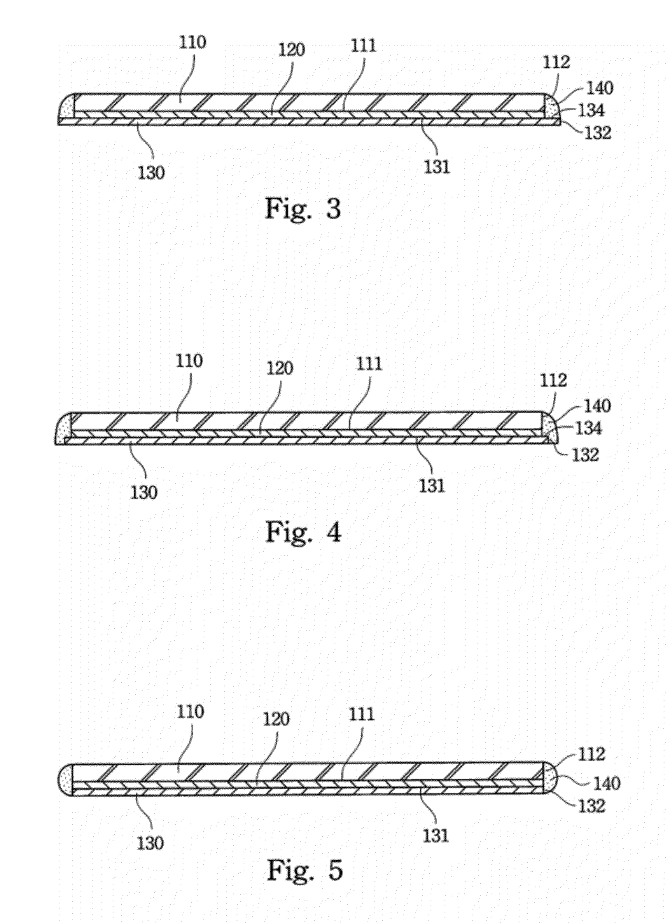

Furthermore, because many breaking defects would be formed on a side surface 112 of the array substrate 110 in glass cutting processes, following external force may cause the array substrate 110 to break along the defects formed on the side surface 112 of the array substrate 110. In order to solve this problem, a protecting layer may be used to cover the side surface 112 of the array substrate 110 in another embodiment of the present disclosure described below, thereby strengthening the strength of the side surface 112 of the array substrate 110. FIG. 3 to FIG. 7 are examples in following descriptions for explaining the embodiments mentioned above. The connecting relationship and the materials mentioned above in the foregoing embodiments would not describe repeatedly in following descriptions but only explain elements needing to be further defined.

FIG. 3 is a cross-sectional view of a display device of another embodiment of the present disclosure, and the cross section position is the same as the FIG. 2. As shown in FIG. 3, the display device of the embodiment further includes a protecting layer 140. The protecting layer 140 covers the side surface 112 of the array substrate 110 for redeeming defects formed on the side surface 112 of the array substrate 110.

In one or other embodiments of the present disclosure, the protecting layer 140 mentioned above is made of an ultraviolet curable material, a heat curable material, or combinations thereof. Similarly, the materials of the protecting layer 140 mentioned above are only examples. Any materials having capability of protecting the array substrate 110 may be applied as the protecting layer 140. Person having ordinary skill in the art can selectively choose the materials of the protecting layer 140 in accordance with practical requirements.

As shown in FIG. 3, in this embodiment, the area of a surface 131 of the supporting layer 130 facing the array substrate 110 may be larger than the area of the surface 111 of the array substrate 110. Therefore at least one step surface 134 would be formed between the supporting layer 130 and the array substrate 110. In order to protect the step surface 134 of the supporting layer 130, the step surface 134 between the supporting layer 130 and the array substrate 110 may be filled and covered with the protecting layer 140 mentioned above.

In addition, although the protecting layer 140 shown in FIG. 3 only covers the side surface 112 of the array substrate 110, the protecting layer 140 also may further cover a side surface 132 (as shown in FIG. 4) of the supporting layer 130 depending on practical requirements (i.e. the supporting layer 130 is made of glass). Person having ordinary skill in the art can selectively choose the embodiments of the protecting layer 140 in accordance with practical requirements.

FIG. 5 is a cross-sectional view of a display device of another embodiment of the present disclosure, and the cross section position is the same as the FIG. 2. The difference between this embodiment and the above embodiment is that the area of the surface 131 of the supporting layer 130 of this embodiment facing the array substrate 110 is equal to the area of the surface 111 of the array substrate 110. As shown in FIG. 5, the protecting layer 140 mentioned above may cover the side surface 112 of the array substrate 110 and the side surface 132 of the supporting layer 130.

Although the protecting layer 140 shown in FIG. 5 covers the side surface 112 of the array substrate 110 and the side surface 132 of the supporting layer 130, the protecting layer 140 also may only cover the side surface 112 of the array substrate 110 for protecting the side surface 112 of the array substrate 110 depending on practical requirements. Person having ordinary skill in the art can selectively choose the embodiments of the protecting layer 140 in accordance with practical requirements.

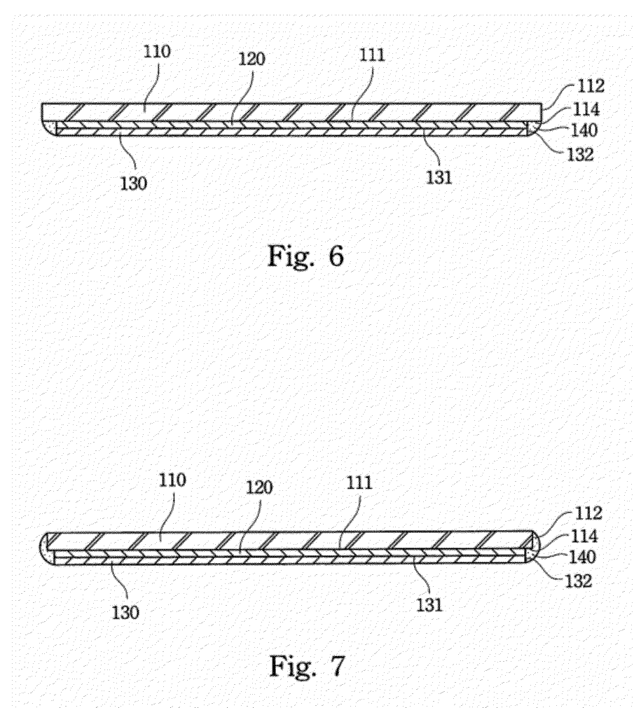

FIG. 6 is a cross-sectional view of a display device of another embodiment of the present disclosure, and the cross section position is the same as the FIG. 2. The difference between this embodiment and the above embodiment is that the area of the surface 131 of the supporting layer 130 facing the array substrate 110 is smaller than the area of the surface 111 of the array substrate 110, thereby forming at least one step surface 114 between the array substrate 110 and the supporting layer 130. In order to protect the step surface 114 of the array substrate 110, the step surface 114 between the array substrate 110 and supporting layer 130 may be filled and covered with the protecting layer 140 mentioned above.

Although the protecting layer 140 shown in FIG. 6 does not cover the side surface 112 of the array substrate 110, the protecting layer 140 also may further cover the side surface 112 (as shown in FIG. 7) of the array substrate 110 for protecting the side surface 112 of the array substrate 110 depending on practical requirements. Person having ordinary skill in the art can selectively choose the embodiments of the protecting layer 140 in accordance with practical requirements.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A display device comprising:
an array substrate;
an electronic paper display medium disposed on the array substrate;
a counter substrate disposed on the electronic paper display medium;
a supporting layer; and
an adhesive adhering the supporting layer to a surface of the array substrate facing away from the electronic paper display medium.

2. The display device as claimed in claim 1, wherein the supporting layer completely covers the surface of the array substrate facing away from the electronic paper display medium.

3. The display device as claimed in claim 1, further comprising:
a protecting layer covering a side surface of the array substrate.

4. The display device as claimed in claim 3, wherein the protecting layer is made of an ultraviolet (UV) curable material, a heat curable material, or combinations thereof.

5. The display device as claimed in claim 1, wherein the area of a surface of the supporting layer facing the array substrate is larger than the area of the surface of the array substrate facing away from the electronic paper display medium, thereby forming at least one step surface between the supporting layer and the array substrate.

6. The display device as claimed in claim 5, further comprising:
a protecting layer covering the step surface between the supporting layer and the array substrate.

7. The display device as claimed in claim 6, wherein the protecting layer further covers a side surface of the supporting layer.

8. The display device as claimed in claim 1, wherein the area of a surface of the supporting layer facing the array substrate is equal to the area of the surface of the array substrate facing away from the electronic paper display medium.

9. The display device as claimed in claim 8, further comprising:
a protecting layer covering a side surface of the array substrate and a side surface of the supporting layer.

10. The display device as claimed in claim 1, wherein the area of a surface of the supporting layer facing the array substrate is smaller than the area of the surface of the array substrate facing away from the electronic paper display medium, thereby forming at least one step surface between the array substrate and the supporting layer.

11. The display device as claimed in claim 10, further comprising:
a protecting layer covering the step surface between the array substrate and the supporting layer.

12. The display device as claimed in claim 11, wherein the protecting layer further covers a side surface of the array substrate.

13. The display device as claimed in claim 1, wherein the adhesive is made of ultraviolet curable adhesive, double sided adhesive tape, or combinations thereof.

14. The display device as claimed in claim 1, wherein the supporting layer is made of glass, tempered glass, metal, plastic, a flexible substrate, or combinations thereof.
